(19) United States
(12) Patent Application Publication
(10) Pub. No.: US 2025/0290888 A1
(43) Pub. Date: Sep. 18, 2025

(54) MEASUREMENT APPARATUS AND MEASURING METHOD

(71) Applicant: SHINKO ELECTRIC INDUSTRIES CO., LTD., Nagano (JP)

(72) Inventors: Tatsuaki DENDA, Nagano (JP); Takumi IKEDA, Nagano (JP)

(21) Appl. No.: 19/073,557

(22) Filed: Mar. 7, 2025

(30) Foreign Application Priority Data
Mar. 12, 2024 (JP) 2024-037943

(51) Int. Cl. G01N 27/22

(52) U.S. Cl. CPC G01N 27/221; G01N 27/226

(57) ABSTRACT

A measurement apparatus includes a substrate having a first surface and a second surface opposite the first surface, with a first electrode and a second electrode disposed on the first surface, and a metal plate positioned opposite the second surface of the substrate across a spacer, wherein the metal plate includes a region overlapping the first electrode and the second electrode in plan view.

### CROSS-REFERENCE TO RELATED APPLICATIONS

The present application is based on and claims priority to Japanese Patent Application No. 2024-037943 filed on Mar. 12, 2024, with the Japanese Patent Office, the entire contents of which are incorporated herein by reference.

### FIELD

The disclosures herein relate to measurement apparatuses and measurement methods.

### BACKGROUND

There is a method of measuring the physical properties of an object using a measurement apparatus having a first electrode and a second electrode, which involves placing the object between the first electrode and the second electrode and then measuring the dielectric constant between the first electrode and the second electrode. When the object of measurement has a glass container and water enclosed in the glass container, for example, this method can measure the concentration of carbonate contained in the water.

Measurement apparatuses as described above are required to have the ability to measure the physical properties of an object with high accuracy without being affected by ambient conditions.

There may be a need to provides a measurement apparatus capable of measuring the physical properties of an object with high accuracy.

### RELATED ART DOCUMENT

### Patent Document

[Patent Document 1] Japanese Laid-Open Patent Publication No. 2023-113339

### SUMMARY

According to an aspect of the embodiment, a measurement apparatus includes a substrate having a first surface and a second surface opposite the first surface, with a first electrode and a second electrode disposed on the first surface, and a metal plate positioned opposite the second surface of the substrate across a spacer, wherein the metal plate includes a region overlapping the first electrode and the second electrode in plan view.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIGS. 1A and 1B are drawings illustrating an example of a measurement apparatus according to a first embodiment;

FIG. 2 is a circuit diagram illustrating an example of a detection circuit connected to the measurement apparatus according to the first embodiment;

FIG. 3 is a drawing explaining an initial value of the capacitance of a variable capacitor;

FIG. 4 is a flowchart illustrating an example of the flow of a preliminary preparation process of the measurement apparatus according to the first embodiment;

FIG. 5 is a flowchart illustrating an example of the flow of measurement performed by the measurement apparatus according to the first embodiment;

FIG. 6 is a cross-sectional view illustrating an example of the measurement apparatus according to a first variation of the first embodiment;

FIG. 7 is a cross-sectional view illustrating an example of the measurement apparatus according to a second variation of the first embodiment;

FIGS. 8A and 8B are drawings illustrating an example of a measurement apparatus according to a second embodiment;

FIG. 9 is a drawing illustrating the addition of a spacer;

FIGS. 10A and 10B are plan views illustrating examples of a holding member;

FIG. 11 is a drawing illustrating a configuration relating to a cutout of the holding member;

FIGS. 12A and 12B are drawings illustrating simulation results.

### DESCRIPTION OF EMBODIMENTS

In the following, embodiments for carrying out the invention will be described with reference to the accompanying drawings. In those drawings, the same constituent parts are referred to by the same reference numerals, and duplicate descriptions thereof may be omitted.

### First Embodiment

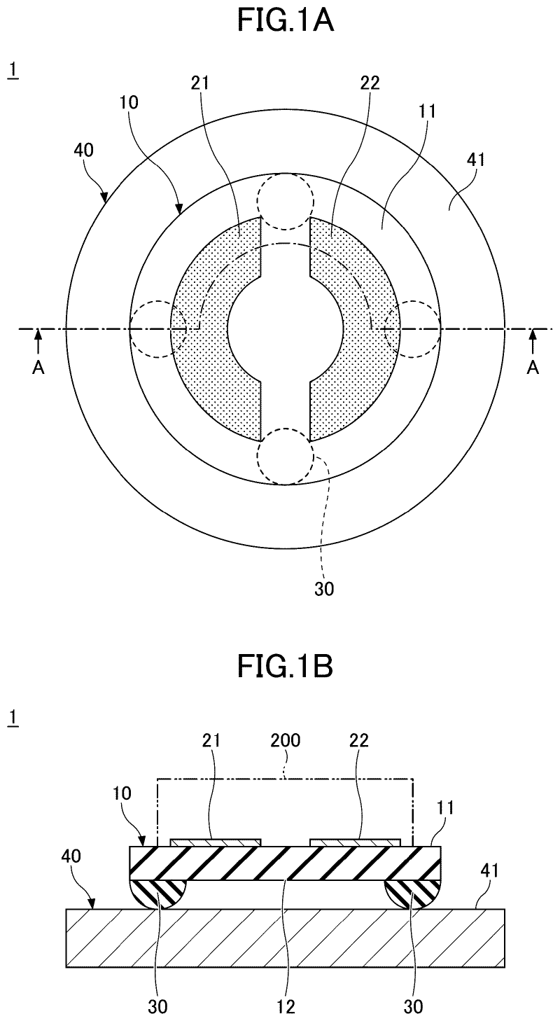

FIGS. 1A and 1B are drawings illustrating an example of a measurement apparatus according to a first embodiment. FIG. 1A is a plan view and FIG. 1B is a cross-sectional view taken along the line A-A in FIG. 1A.

Referring to FIGS. 1A and 1B, the measurement apparatus 1 includes a substrate 10, spacers 30, and a metal plate 40.

The substrate 10 has a first surface 11 and a second surface 12 opposite the first surface 11. In the example illustrated in FIG. 1, the first surface 11 is the upper surface and the second surface 12 is the lower surface. The substrate 10 has, for example, a circular planar shape. The substrate 10 is an insulating substrate. For example, the material of the substrate 10 is glass epoxy or the like. The thickness of the substrate 10 is, for example, about 600 μm to 1500 μm.

A first electrode 21 and a second electrode 22 are provided on the first surface 11 of the substrate 10. The first electrode 21 and the second electrode 22 are electrically insulated from each other. The first electrode 21 and the second electrode 22 each have a planar strip shape forming a circular arc, for example. The first electrode 21 and the second electrode 22 are curved so as to be separated from each other at the centers. One end of the first electrode 21 faces one end of the second electrode 22, and the other end of the first electrode 21 faces the other end of the second electrode 22. The materials of the first electrode 21 and the second electrode 22 are, for example, copper. The thickness of the first electrode 21 and the second electrode 22 is, for example, about 12 μm to 30 μm.

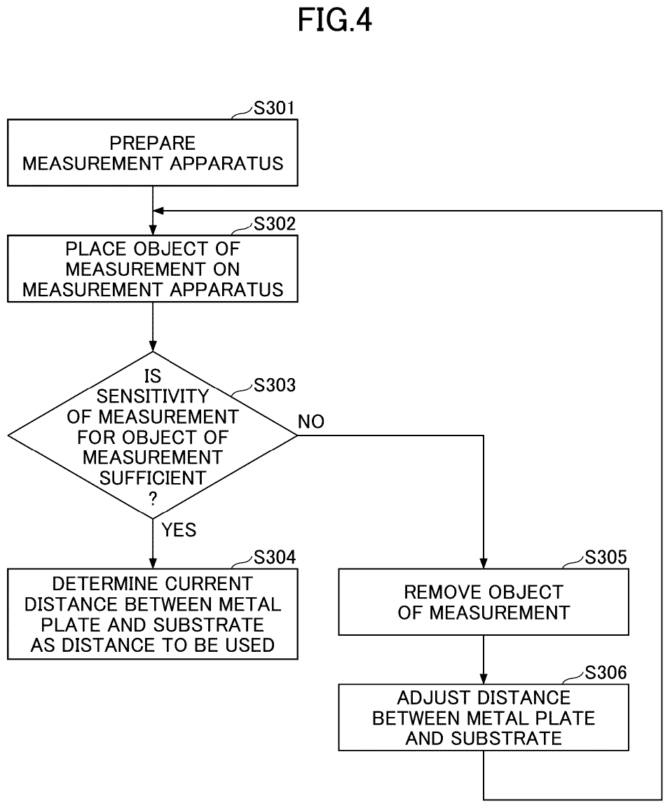

The spacers 30 are provided on the second surface 12 of the substrate 10. The spacers 30 can be arranged, for example, on the outer periphery of the second surface 12 of the substrate 10. In the example illustrated in FIGS. 1A and 1B, 4 spacers 30 are provided, but the number of spacers 30 can be set freely. In the example illustrated in FIGS. 1A and 1B, the spacers 30 are in contact with the second surface 12 of the substrate 10 and the upper surface 41 of the metal plate 40 that is oriented toward the substrate 10. The material of the spacers 30 is, for example, rubber or resin.

The metal plate 40 is disposed on the second surface 12 side of the substrate 10 via the spacers 30. The metal plate 40 is not in contact with the substrate 10, and a space exists between the second surface 12 of the substrate 10 and the upper surface 41 of the metal plate 40. The distance between the second surface 12 of the substrate 10 and the upper surface 41 of the metal plate 40 may be set according to need, but may be, for example, from 1 mm to 20 mm.

The metal plate 40 may be circular in plan view, for example. When the metal plate 40 is circular in plan view, the diameter may be, for example, from 50 mm to 150 mm. The material of the metal plate 40 may be, for example, aluminum, copper, stainless steel, or the like. The thickness of the metal plate 40 may be, for example, from 5 mm to 20 mm. The metal plate 40 has a region overlapping the first electrode 21 and the second electrode 22 in plan view. The metal plate 40 is not electrically connected to the substrate 10. That is, the potential of the metal plate 40 is floating.

The object of measurement 200 is placed on the first surface 11 of the substrate 10 so that the physical properties of interest can be measured using the first electrode 21 and the second electrode 22. The object of measurement 200 includes, for example, a glass container and a substance such as water enclosed in the glass container. For example, when the object of measurement 200 has a glass container and water enclosed in the glass container, the concentration of carbonate (calcium carbonate, magnesium carbonate, etc.) contained in the water may be measured.

Since the dielectric constant between the first electrode 21 and the second electrode 22 differs depending on the concentration of carbonate, the concentration of carbonate can be measured without contact by measuring the dielectric constant between the first electrode 21 and the second electrode 22. This arrangement effectively suppresses deterioration in accuracy that would occur due to corrosion of the first electrode 21 and the second electrode 22.

The measurement apparatus 1 may include a temperature sensor. For example, when the concentration of carbonate in water is temperature dependent, the concentration of carbonate may be measured simultaneously with the temperature of water using the first electrode 21 and the second electrode 22. This arrangement enables the highly accurate measurement of physical properties according to the temperature even when the physical properties are temperature dependent.

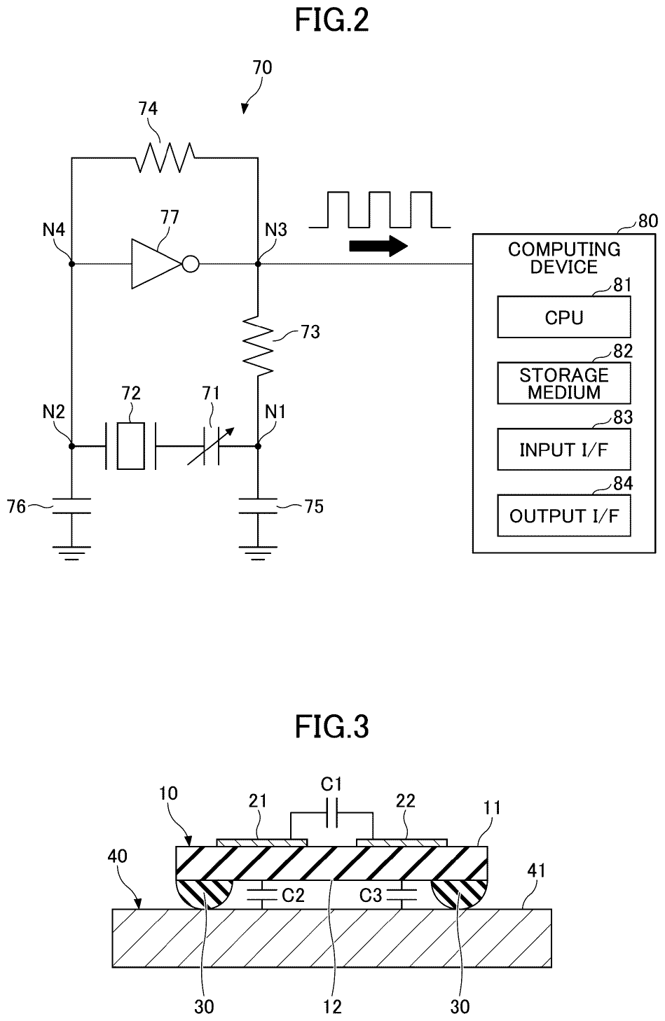

FIG. 2 is a circuit diagram illustrating an example of a detection circuit connected to the measurement apparatus according to the first embodiment. The first electrode 21 and the second electrode 22 of the measurement apparatus 1 may be connected to a detection circuit 70 illustrated in FIG. 2. The detection circuit 70 is used for detecting the dielectric constant between the first electrode 21 and the second electrode 22.

The detection circuit 70 includes a variable capacitor 71, a quartz crystal (Xtal) 72, a resistive element 73, a resistive element 74, a capacitor 75, a capacitor 76, and an inverter 77. The detection circuit 70 further includes nodes N1, N2, N3, and N4. The variable capacitor 71 includes the first electrode 21 and the second electrode 22, and the capacitance of the variable capacitor 71 changes according to the dielectric constant between the first electrode 21 and the second electrode 22.

The variable capacitor 71 and the quartz crystal 72 are connected in series between the node N1 and the node N2. One end of the capacitor 75 is connected to the node N1, and the other end of the capacitor 75 is grounded. One end of the capacitor 76 is connected to the node N2, and the other end of the capacitor 76 is grounded. The resistive element 73 is connected between the node N1 and the node N3. The node N2 and the node N4 are short-circuited. The resistive element 74 and the inverter 77 are connected in parallel between the node N3 and the node N4. The input of the inverter 77 is connected to the node N4, and the output is connected to the node N3.

In the detection circuit 70, the capacitance of the variable capacitor 71 changes according to the dielectric constant between the first electrode 21 and the second electrode 22, and the frequency of the AC signal output from the node N3 changes according to the capacitance of the variable capacitor 71. As a result, the dielectric constant between the first electrode 21 and the second electrode 22 can be derived by analyzing the frequency of the AC signal. As described above, when the object of measurement 200 has a glass container and water enclosed in the glass container, the concentration of carbonate in the water can be determined from the dielectric constant between the first electrode 21 and the second electrode 22. The AC signal output from the node N3 may sometimes be called a clock signal.

The detection circuit 70 is connected to, for example, a computing device 80. The computing device 80 is, for example, a computer, and includes a central processing unit (CPU) 81, a storage medium 82 such as a memory, an input interface (I/F) 83, and an output interface (I/F) 84. The storage medium 82 stores programs for controlling various processes executed in the measurement system using the measurement apparatus 1. The computing device 80 receives signals from the outside through the input interface 83 and transmits signals to the outside through the output interface 84. The computing device 80 receives an output signal (AC signal) from the detection circuit 70, and the CPU 81 executes a program stored in the storage medium 82. This arrangement enables the measurement of the concentration of carbonate in the water contained in the object of measurement 200.

The above program is stored, for example, in a recording medium readable by a computer, and installed from the recording medium to the storage medium 82 of the computing device 80. Examples of the recording medium readable by the computer include a hard disk (HD), a flexible disk (FD), a compact disk (CD), a magnet optical desk (MO), a memory card, and the like. The program may be downloaded from a server via the Internet and installed in the storage medium 82 of the computing device 80. In addition to the above program, reference data or the like created using calibration-curve data obtained in advance may be recorded in the storage medium 82.

In the measurement system using the measurement apparatus 1 as described above, the dielectric constant between the first electrode 21 and the second electrode 22 changes in accordance with the dielectric constant of the object of measurement 200, causing corresponding changes in the frequency of the AC signal. Analyzing the frequency of the AC signal thus enables the measurement of physical properties that depend on the dielectric constant of the object of measurement 200.

It may be noted the dielectric constant is highly susceptible to ambient conditions. When the dielectric constant between the first electrode 21 and the second electrode 22 changes due to the influence of ambient conditions, the frequency of the AC signal also changes. This causes noise in the measurement of physical properties of the object of measurement 200 and prevents accurate measurement. In consideration of this, the measurement apparatus 1 is equipped with the metal plate 40 so as to reduce the influence of the ambient conditions.

For example, if the measurement apparatus 1 did not have the metal plate 40, and the measurement apparatus 1 were placed on a metal desk, the dielectric constant between the first electrode 21 and the second electrode 22 would be affected by the desk. Further, a person approaching the measurement apparatus 1 would also affect the dielectric constant between the first electrode 21 and the second electrode 22. In contrast, provision of the metal plate 40 reduces the influence of ambient conditions, thereby helping to avoid such problems. As a result, the measurement apparatus 1 can monitor the physical properties of the object of measurement 200 with high accuracy.

It is preferable that the area of the surface of the metal plate 40 oriented toward the substrate 10 is larger than the area of the surfaces of the first electrode 21 and the second electrode 22 oriented toward the substrate 10. This arrangement effectively provides the effect of reducing the influence of ambient conditions. It is more preferable that the area of the surface of the metal plate 40 oriented toward the substrate 10 is larger than the area of the second surface 12 of the substrate 10. This arrangement further enhances the effect of reducing the influence of ambient conditions.

It may be further noted that the provision of the metal plate 40 in the measurement apparatus 1 may achieve a varying initial value of the capacitance of the variable capacitor 71. This will be described with reference to FIG. 3. The initial value of the capacitance of the variable capacitor 71 refers to the capacitance of the variable capacitor 71 observed when the object of measurement 200 is not placed on the first surface 11 of the substrate 10.

In FIG. 3, C1 is the capacitance between the first electrode 21 and the second electrode 22. C2 is the capacitance between the first electrode 21 and the metal plate 40. C3 is the capacitance between the second electrode 22 and the metal plate 40. In FIG. 3, series-connected C2 and C3 is connected in parallel to C1. Therefore, the total capacitance of C1, C2, and C3 is C1+(C2×C3)/(C2+C3). This is the initial value of the capacitance of the variable capacitor 71.

C2 and C3 vary depending on the distance between the second surface 12 of the substrate 10 and the upper surface 41 of the metal plate 40. For example, a change in the height of the spacers 30 causes a change in the distance between the second surface 12 of the substrate 10 and the upper surface 41 of the metal plate 40, thereby changing the capacitances of C2 and C3. In this manner, the initial value of the capacitance of the variable capacitor 71 can be adjusted.

In the measurement apparatus 1, the sensitivity of object measurement varies depending on the distance between the metal plate 40 and the substrate 10. The distance between the metal plate 40 for achieving sufficient and the substrate 10 measurement sensitivity varies for each object of measurement. It is thus preferable to perform a preliminary preparation step in which the distance between the metal plate 40 and the substrate 10 for achieving sufficient measurement sensitivity is determined and recorded in advance for each object of measurement. In actual measurement, the distance between the metal plate 40 and the substrate 10 is preferably adjusted to the distance recorded in the preliminary preparation process before performing measurement. This makes it possible to measure with sufficient sensitivity even if the type of object of measurement changes. If the type of object of measurement remains the same, a plurality of samples can be measured with sufficient sensitivity by adjusting the distance between the metal plate 40 and the substrate 10 only once.

In order to adjust the distance between the second surface 12 of the substrate 10 and the upper surface 41 of the metal plate 40, for example, the substrate 10 may be screwed to the spacers 30. This allows the substrate 10 to be freely detached. For example, the distance between the second surface 12 of the substrate 10 and the upper surface 41 of the metal plate 40 may be increased by detaching the substrate 10, adding additional spacers between the substrate 10 and the spacers 30, and screwing the substrate 10.

FIG. 4 is a flowchart illustrating an example of the flow of the preliminary preparation process of the measurement apparatus according to the first embodiment. As described above, the sensitivity of object measurement varies depending on the distance between the metal plate 40 and the substrate 10. It is thus preferable to perform a preliminary preparation step in which the distance between the metal plate 40 and the substrate 10 is adjusted to determine the distance at which the sensitivity of object measurement becomes a predetermined value or more.

First, in step S301, the measurement apparatus 1 is prepared. Next, in step S302, the object of measurement is placed on the first electrode 21 and the second electrode 22 of the measurement apparatus 1. Then, in step S303, it is determined whether or not the sensitivity of measurement of the object is sufficient. Here, the sensitivity of measurement is determined by the difference in frequency between the clock signal in the initial state of the object of measurement and the clock signal after a passage of time. For example, when the clock signal in the initial state is 32.0001 MHz and the clock signal after passage of time is 32.0002 MHz, there is a difference of 100 Hz. In this case, the sensitivity of the measurement is 100. In this embodiment, the sensitivity of the measurement is determined to be sufficient when the sensitivity of measurement is 50 or more.

If the measurement sensitivity is determined to be sufficient (YES) in step S303, the process proceeds to step S304, in which the current distance between the metal plate 40 and the substrate 10 in step S303 is determined to be the distance to be used for measurement. If the measurement sensitivity is determined to be not sufficient (NO) in step S303, the process proceeds to step S305, in which the object of measurement is removed. In step S306, the distance between the metal plate 40 and the substrate 10 is adjusted, followed by returning to step S302. Thereafter, steps S302 to S306 are repeated until the measurement sensitivity is determined to be sufficient. Then, the distance between the metal plate 40 and the substrate 10 used when the measurement sensitivity is determined to be sufficient in step S303 is determined to be the distance to be used in the measurement.

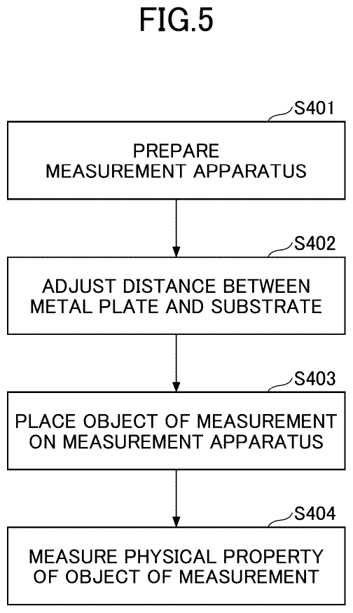

FIG. 5 is a flowchart illustrating an example of the flow of measurement performed by the measurement apparatus according to the first embodiment. First, in step S401, the measurement apparatus 1 is prepared. Next, in step S402, the distance between the metal plate 40 and the substrate 10 in the measurement apparatus 1 is adjusted to a distance matching the object of measurement. Here, the distance matching the object of measurement is the distance determined in step S304 of the preliminary preparation step illustrated in FIG. 4. In step S403, the object of measurement is placed on the first electrode 21 and the second electrode 22 of the measurement apparatus 1. In step S404, the physical properties of the object of measurement are measured based on the dielectric constant between the first electrode 21 and the second electrode 22. Since the distance between the metal plate 40 and the substrate 10 is adjusted to achieve sufficient measurement sensitivity, the physical properties of the object of measurement can be accurately measured.

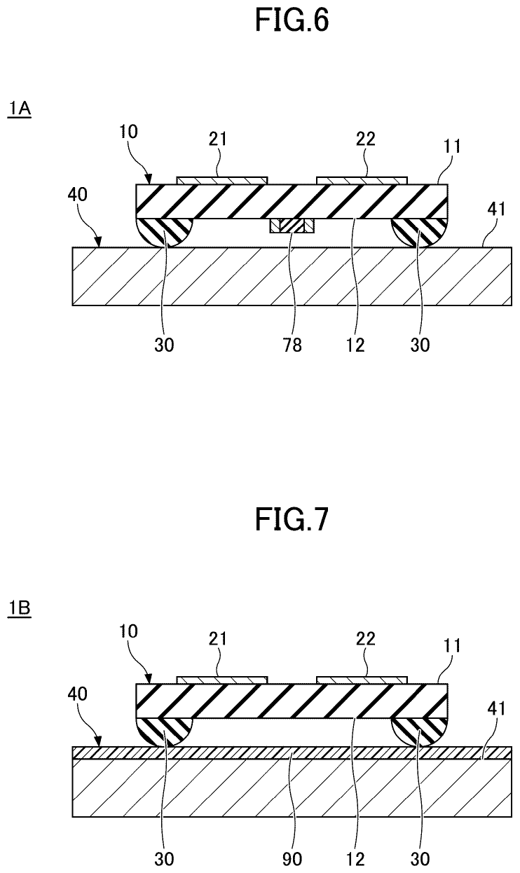

FIG. 6 is a cross-sectional view illustrating an example of a measurement apparatus according to a first variation of the first embodiment. In the previously described configuration illustrated in FIG. 1, even when the distance between the second surface 12 of the substrate 10 and the upper surface 41 of the metal plate 40 is set to the shortest, the initial value of the capacitance of the variable capacitor 71 may be insufficient. In consideration of this, a measurement apparatus 1A illustrated in FIG. 6 is configured such that a capacitor 78 is mounted on the second surface 12 of the substrate 10 and electrically connected between the first electrode 21 and the second electrode 22. This arrangement effectively achieves a relatively large initial value of the capacitance of the variable capacitor 71. The capacitance may then be reduced as appropriate by increasing the distance between the second surface 12 of the substrate 10 and the upper surface 41 of the metal plate 40.

It should be noted that the spacers 30 may be detachable from the substrate 10 and the metal plate 40 by use of a screw mechanism or the like. In this case, by preparing a plurality of kinds of spacers 30 having different heights and selecting spacers 30 having an appropriate height, the distance between the second surface 12 of the substrate 10 and the upper surface 41 of the metal plate 40 may be adjusted in a desired direction, i.e., either the direction to be increased or the direction to be decreased.

FIG. 7 is a cross-sectional view illustrating an example of a measurement apparatus according to a second variation of the first embodiment. A measurement apparatus 1B may be configured as illustrated in FIG. 7, with a high dielectric constant plate 90 provided on the upper surface 41 of the metal plate 40 which is oriented toward the substrate 10. Examples of the material of the high dielectric constant plate 90 include aluminum oxide and urethane. This arrangement effectively provides a relatively high initial value for the capacitance of the variable capacitor 71 in comparison with the structure with no high dielectric constant plate 90 when the distance between the second surface 12 of the substrate 10 and the upper surface 41 of the metal plate 40 is the same. In the instant application, a high dielectric constant refers to a relative dielectric constant of 5 or greater.

### Second Embodiment

The second embodiment is directed to an example of a measurement apparatus with spacers of a different shape. In connection with the second embodiment, a description may be omitted with respect to the same constituent parts as those of the already described embodiment.

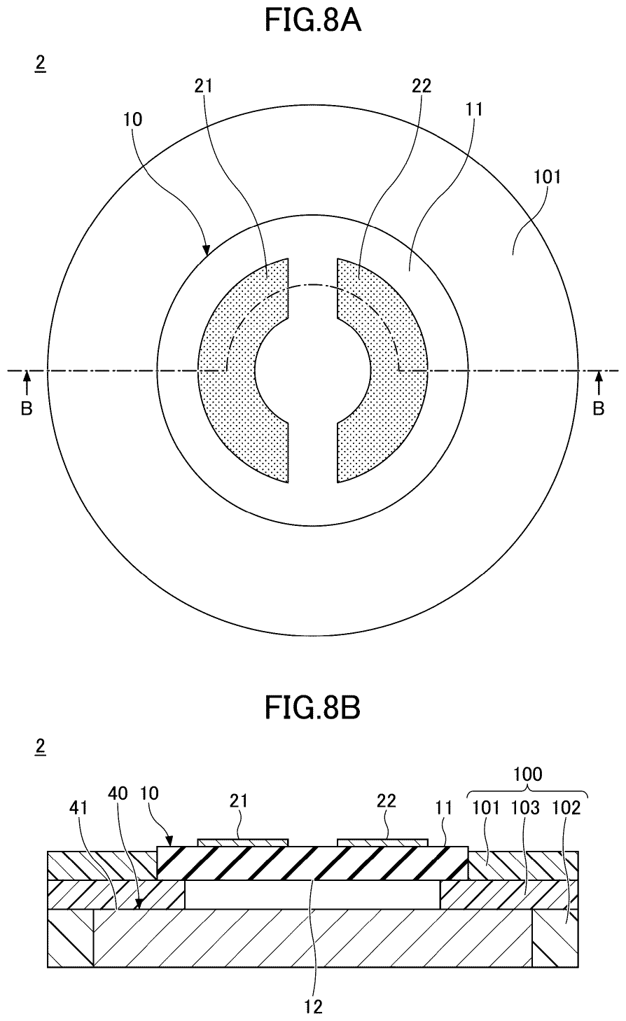

FIGS. 8A and 8B are drawings illustrating an example of a measurement apparatus according to the second embodiment. FIG. 8A is a plan view, and FIG. 8B is a cross-sectional view taken along the line B-B in FIG. 8A.

Referring to FIGS. 8A and 8B, a measurement apparatus 2 includes a substrate 10, a metal plate 40, and a holding member 100. The holding member 100 holds the substrate 10 and the metal plate 40. The holding member 100 may be formed of resin, for example.

The holding member 100 includes a substrate holder 101, a metal plate holder 102, and a spacer 103. The substrate holder 101 is arranged outside the outer lateral surface of the substrate 10. The metal plate holder 102 is arranged outside the outer lateral surface of the metal plate 40. The spacer 103 is arranged between the substrate holder 101 and the metal plate holder 102 to determine the distance between the second surface 12 of the substrate 10 and the upper surface 41 of the metal plate 40.

The substrate holder 101 and the spacer 103 may be seamlessly formed as a single piece or may be formed as separate pieces joined together. The metal plate holder 102 and the spacer 103 may be seamlessly formed as a single piece or may be formed as separate pieces joined together. Further, the substrate holder 101, the metal plate holder 102, and the spacer 103 may all be seamlessly formed as a single piece.

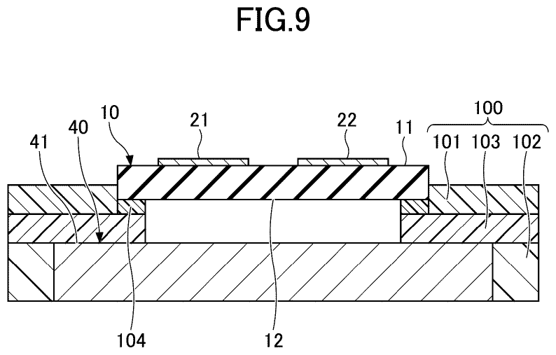

In this structure, for example, the substrate 10 may be freely detachable by screwing the substrate 10 to the spacer 103. With this arrangement, the distance between the second surface 12 of the substrate 10 and the upper surface 41 of the metal plate 40 may be increased by detaching the substrate 10 and then screwing the substrate 10 after adding a spacer 104 between the substrate 10 and the spacer 103 as illustrated in FIG. 9, for example.

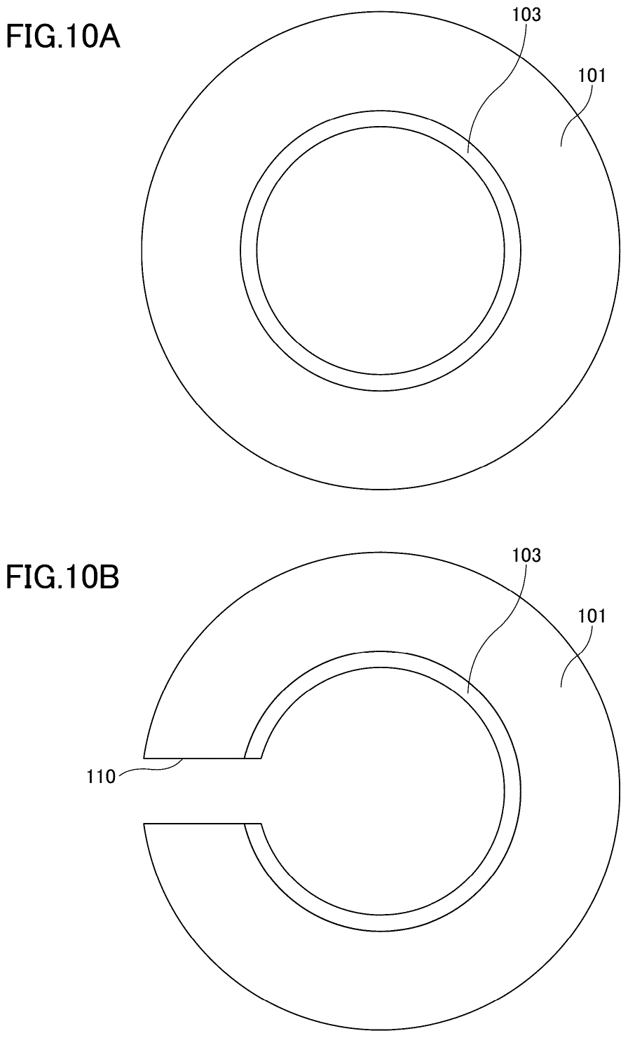

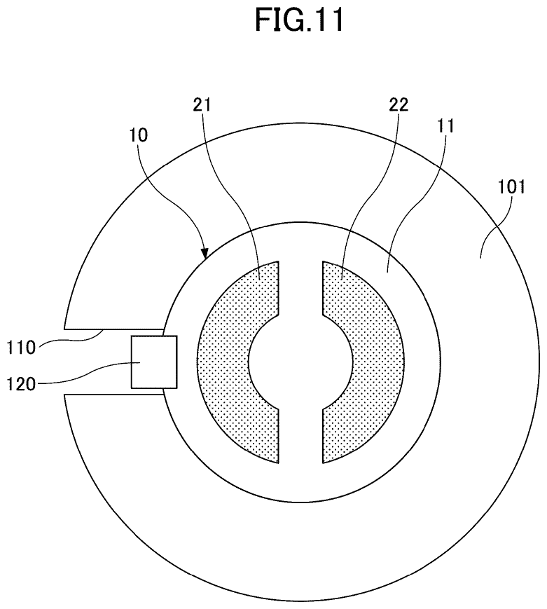

FIGS. 10A and 10B are plan views illustrating examples of the holding member. The holding member 100 may be annular in plan view as illustrated in FIG. 10A, but may have a cutout 110 as illustrated in FIG. 10B. The cutout 110 may be present in the substrate holder 101, the metal plate holder 102, and the spacer 103 so as to expose a part of the outer lateral surfaces of the substrate 10 and the metal plate 40. For example, as illustrated in FIG. 11, a connector 120 provided on the substrate 10 may be arranged at the position of the cutout 110 in plan view. In this manner, the holding member 100 effectively holds the substrate 10 even when the connector 120 is arranged on the outer peripheral part of the substrate 10. The connector 120 may be arranged on the first surface 11 and/or the second surface 12 of the substrate 10.

### Simulation

A simulation is performed in the case where a stainless-steel plate is arranged under the metal plate 40 of the measurement apparatus 1 and the case where no stainless-steel plate is arranged. Specifically, with respect to these two cases, the values of C1, C2, and C3 illustrated in FIG. 3 and the value of “C1+(C2×C3)/(C2+C3)” (referred to as Ctotal), which is the initial value of the capacitance of the variable capacitor 71, are calculated using the simulation software “ANSYS Electronics Desktop 2022R2”.

A circular plate with a diameter of 100 mm and a thickness of 10 mm is used as the metal plate 40. The metal plate 40 is larger than the substrate 10. The stainless-steel plate is a rectangle plate with dimensions of 300 mm×300 mm and a thickness of 30 mm. When the stainless-steel plate is arranged, the center of the stainless-steel plate is aligned with the center of the metal plate 40. The capacitances are calculated for each of the distances of 2 mm, 4 mm, 6 mm, and 8 mm between the second surface 12 of the substrate 10 and the metal plate 40.

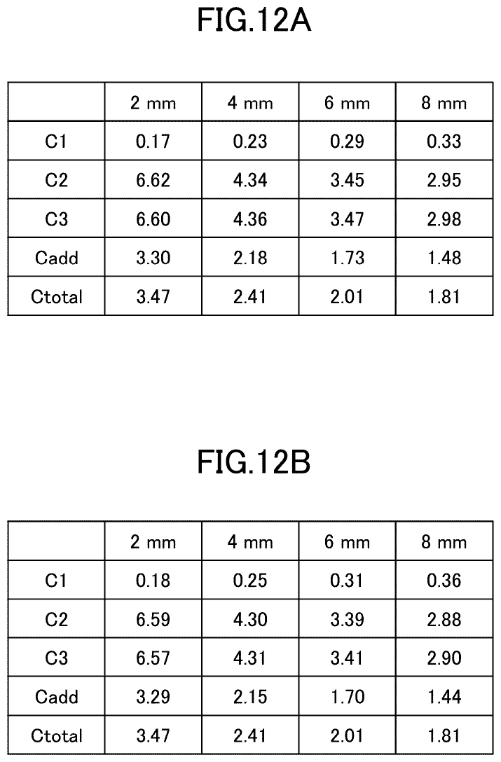

FIGS. 12A and 12B provide simulation results. FIG. 12A indicates the results when the stainless-steel plate is arranged under the metal plate 40, and FIG. 12B indicates the results when the stainless-steel plate is not arranged. In addition to C1, C2, C3, and Ctotal, Cadd=(C2×C3)/(C2+C3) is also shown in FIGS. 12A and 12B. The unit of capacitance is pF.

A check of the values of Ctotal reveals agreement between FIG. 12A and FIG. 12B. It can thus be concluded that the value of Ctotal is hardly influenced by the presence of the stainless-steel plate. According to another study by the inventors, the value of Ctotal is greatly influenced by the presence of the stainless-steel plate if the measurement apparatus 1 does not have the metal plate 40. The results shown in FIGS. 12A and 12B thus confirm that the provision of the metal plate 40 effectively reduces the influence of the ambient conditions. Moreover, it is understood from FIGS. 12A and 12B that the value of Ctotal can be adjusted by changing the distance between the second surface 12 of the substrate 10 and the metal plate 40.

According to the disclosed technology, a measurement apparatus is provided that is capable of measuring the physical properties of an object with high accuracy.

The disclosures herein nonexclusively contain the subject matter set out in the following clauses.

Clause 1. A measuring method comprising:
preparing an object of measurement;
preparing a measurement apparatus which includes a substrate having a first surface and a second surface opposite the first surface, with a first electrode and a second electrode disposed on the first surface, and a metal plate positioned opposite the second surface of the substrate across one or more spacers;
adjusting a distance between the metal plate and the substrate to a distance matching the object of measurement;
placing the object of measurement on the first electrode and the second electrode after the adjusting the distance; and
measuring a physical property of the object of measurement based on a dielectric constant between the first electrode and the second electrode.

Clause 2. The measurement method according to clause 1, further comprising tuning the distance between the metal plate and the substrate to determine a distance at which sensitivity of measurement of the object is equal to or greater than a predetermined value;
wherein the distance matching the object of measurement is the determined distance.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A measurement apparatus comprising:
a substrate having a first surface and a second surface opposite the first surface, with a first electrode and a second electrode disposed on the first surface;
a metal plate positioned opposite the second surface of the substrate across a spacer;
wherein the metal plate includes a region overlapping the first electrode and the second electrode in plan view.

2. The measurement apparatus according to claim 1, wherein an area of a surface of the metal plate oriented toward the substrate is larger than a total area of surfaces of the first electrode and the second electrode oriented toward the substrate.

3. The measurement apparatus according to claim 1, further comprising a capacitor mounted on the second surface of the substrate and electrically connected between the first electrode and the second electrode.

4. The measurement apparatus according to claim 1, further comprising a high dielectric constant plate disposed on a surface of the metal plate, the surface of the metal plate being oriented toward the substrate.

5. The measurement apparatus according to claim 1, further comprising a holding member configured to hold the substrate and the metal plate,
wherein the holding member includes:
a substrate holder arranged outside an outer lateral surface of the substrate;
a metal plate holder arranged outside an outer lateral surface of the metal plate; and
the spacer arranged between the substrate holder and the metal plate holder to determine a distance between the substrate and the metal plate.

6. The measurement apparatus according to claim 5, further comprising a connector provided on the substrate, wherein the substrate holder, the metal plate holder, and the spacer have a cutout exposing a part of the outer lateral surfaces of the substrate and the metal plate, and the connector is arranged at a position of the cutout in plan view.
